(19) United States
(12) Patent Application Publication
(10) Pub. No.: US 2026/0037612 A1
(43) Pub. Date: Feb. 5, 2026

(54) SYSTEM AND METHODS FOR AUTHENTICATION OF PCIe DEVICES USING PCIe SWITCH

(71) Applicant: Microchip Technology Inc., Chandler, AZ (US)

(72) Inventors: Prasanna Vengateshan Varadharajan, Chennai (IN); Richard Cannon, Frodsham (GB); Atish Ghosh, Austin, TX (US); Kumaravel Thiagarajan, Chennai (IN); Pragash Mangalapandian, Chennai (IN)

(73) Assignee: Microchip Technology Inc., Chandler, AZ (US)

(21) Appl. No.: 19/265,081

(22) Filed: Jul. 10, 2025

(30) Foreign Application Priority Data
Aug. 1, 2024 (IN) 202411058530

(51) Int. Cl. G06F 21/44; G06F 13/40; G06F 21/85

(52) U.S. Cl. CPC G06F 21/44; G06F 13/4022; G06F 21/85

(57) ABSTRACT

A method including attaching a plurality of hosts to separate partitions in a PCIe switch, at reset, routing all downstream ports of the PCIe switch internally to an internal partition of the PCIe switch, detecting, with an embedded CPU, all PCIe devices connected to the internal partition, and authenticating the devices with a control circuit. Upon authentication, connecting the PCIe devices to hosts connected to upstream ports of the PCIe switch via separate partitions.

### CROSS-REFERENCE TO RELATED APPLICATIONS

This application claims priority to India patent application No. 202411058530, filed Aug. 1, 2024, which is hereby incorporated by reference in its entirety for all purposes as if fully set forth herein.

### TECHNICAL FIELD

The present disclosure relates to electronic devices such as computers sharing device resources and, more particularly, to a system and methods for Peripheral Component Interconnect Express (PCIe) devices to be authenticated using a PCIe switch.

### BACKGROUND

Peripheral Component Interconnect Express (PCIe) is a high-speed standard used to connect hardware components inside computers. An Upstream Port (USP) may be used to interface with the host computing platform's PCIe root complex, which may serve as a sort of bridge between the CPU, memory, and PCIe bus. Upstream is toward the root complex. A Downstream Port (DSP) points away from the root complex and connects to individual PCIe endpoint devices, such as graphics cards, storage controllers, network cards or switches. The downstream port facilitates data flow from the root complex to the connected devices. A PCIe switch has at least one upstream port and usually has multiple downstream ports. The upstream port connects to the root complex, and the downstream port connects to various endpoint devices or switches. A PCIe switch may allow multiple devices to share a single PCIe root port.

The Security Protocol and Data Model (SPDM) Specification defines messages, data objects, sequences, and states for performing message exchanges over a variety of transport and physical media. The description of message exchanges includes authentication and provisioning of hardware identities, measurement for firmware and/or hardware identities, session key exchange protocols to enable confidentiality with integrity-protected data communication, and other related capabilities. The SPDM enables efficient access to low-level security capabilities and operations. Other mechanisms, including non-DMTF-defined mechanisms, can use the SPDM.

Examples of the present disclosure may address one or more of these issues.

### SUMMARY

According to an aspect, there is provided an apparatus, comprising: an upstream PCIe port configured to connect to a first host; a first downstream PCIe port to connect to a first PCIe device through a first partition of the apparatus; and a control circuit of an internal partition of the apparatus configured to: operate the first downstream PCIe port in an authentication mode; detect attachment of the first PCIe device at the first downstream PCIe port; authenticate the first PCIe device; upon authentication of the first PCIe device, route the first PCIe device to the first upstream PCIe port for connection through the first partition to the first host; and operate the first downstream PCIe port in a pass-through mode.

An aspect as in the preceding paragraph provides an apparatus, comprising: a second upstream PCIe port configured to connect to a second host in a second partition of the apparatus, and a second downstream PCIe port configured to connect to a second PCIe device through a second partition of the apparatus, wherein: the first host is configured to access the first upstream PCIe port in the first partition of the apparatus; the second host is configured to access the second upstream PCIe port in the second partition of the apparatus; and when one or more of the first and second downstream ports is in the authentication mode, the control circuit is configured to access the respective downstream ports from the internal partition of the apparatus, wherein the first partition, the second partition, and the internal partition of the apparatus are separate partitions.

An aspect as in one of the preceding two paragraphs provides an apparatus, wherein the internal partition is isolated from the first host and the second host.

An aspect as in one of the preceding three paragraphs provides an apparatus, wherein when the first downstream PCIe port is in the authentication mode the control circuit is configured to route PCIe signals between the first PCIe device connected to the first downstream PCIe port and the internal partition for authentication of the first PCIe device.

An aspect as in one of the preceding four paragraphs provides an apparatus, wherein when the first downstream PCIe port is in the authentication mode the control circuit is configured to cause the first downstream PCIe port to isolate the first PCIe device from the first host before authentication of the first PCIe device.

An aspect as in one of the preceding five paragraphs provides an apparatus, wherein when the first downstream PCIe port is in the pass-through mode the control circuit is configured to cause the first downstream PCIe port to allow the first PCIe device to be connected to the first host through the first partition after authentication of the first PCIe device connected to the first downstream PCIe port.

An aspect as in one of the preceding six paragraphs provides an apparatus, wherein the control circuit is configured to switch operating the first downstream PCIe port between authentication mode and pass-through mode based on a predetermined event or a predetermined condition. The predetermined event or predetermined condition may include device attach, device removal, hot reset, bus errors, link states and other such conditions without limitation.

An aspect as in one of the preceding seven paragraphs provides an apparatus, wherein the control circuit is configured to simultaneously operate the first downstream PCIe port in the pass-through mode and to operate the second downstream PCIe port in the authentication mode or vice versa.

An aspect as in one of the preceding eight paragraphs provides an apparatus, wherein the first downstream PCIe port utilizes PCIe and/or non-PCIe communication for authentication of the first PCIe device. Non-PCIe communication may include but not limited to protocols like I2C (Inter Integrated Circuit Communication) or SMBus (System Management Bus) or TWI (Two Wire Interface).

An aspect as in one of the preceding nine paragraphs provides an apparatus, wherein the first downstream PCIe port includes a separate authentication path from a PCIe pass-through path, wherein the authentication path is for authentication of the first PCIe device.

An aspect as in one of the preceding ten paragraphs provides an apparatus, wherein the control circuit is configured to handle PCIe device connect or removal events for the first downstream PCIe port and the second downstream PCIe port.

According to an aspect, there is provided a method comprising: authenticating, via a control circuit embedded in an internal partition of a PCIe switch, a first PCIe device connected to a first downstream PCIe port; and upon authentication of the first PCIe device, connecting the first PCIe device to a first upstream host through a first partition of the PCIe switch, wherein the internal partition and the first partition are separate.

An aspect as in the preceding paragraph provides a method, wherein authenticating comprises operating the first downstream PCIe port in an authentication mode.

An aspect as in one of the preceding two paragraphs provides a method, wherein connecting comprises operating the first downstream PCIe port in a pass-through mode.

An aspect as in one of the preceding two paragraphs provides a method, comprising: authenticating, via the control circuit, a second PCIe device connected to a second downstream PCIe port; and upon authentication of the second PCIe device, connecting the second PCIe device to a second upstream host through a second partition of the PCIe switch, wherein the internal partition, the first partition, and the second partition are separate.

An aspect as in one of the preceding three paragraphs provides a method, wherein authenticating comprises operating the second downstream PCIe port in an authentication mode, and wherein connecting comprises operating the second downstream PCIe port in a pass-through mode.

An aspect as in one of the preceding four paragraphs provides a method, comprising simultaneously operating the first downstream PCIe port in the pass-through mode and operating the second downstream PCIe port in the authentication mode or vice versa.

According to an aspect, there is provided a system, comprising: a PCIe switch comprising: a first upstream PCIe port connected to a first downstream PCIe port via a first partition; a control circuit connected to the first downstream port via an internal partition, wherein the internal partition and the first partition are separate; a first host connected to the first upstream PCIe port; and a first downstream PCIe device connected to the first downstream PCIe port; wherein the control circuit is configured to: operate the first downstream PCIe port in an authentication mode; detect attachment of the first PCIe device at the first downstream PCIe port; authenticate the first PCIe device; upon authentication of the first PCIe device, route the first PCIe device to the first upstream PCIe port for connection through the first partition to the first host; and operate the first downstream PCIe port in a pass-through mode.

An aspect as in the preceding paragraph provides a system, wherein the PCIe switch comprises: a second upstream PCIe port connected to a second downstream PCIe Port via a second partition, wherein the control circuit is connected to the second downstream port via the internal partition, wherein the internal partition and the second partition are separate; wherein the system comprises: a second host connected to the second upstream PCIe port; a second downstream PCIe device connected to the second downstream PCIe port; wherein the control circuit is configured to: operate the second downstream PCIe port in an authentication mode; detect attachment of the second PCIe device at the second downstream PCIe port; authenticate the second PCIe device; upon authentication of the second PCIe device, route the second PCIe device to the second upstream PCIe port for connection through the second partition to the second host; and operate the second downstream PCIe port in a pass-through mode.

An aspect as in one of the preceding two paragraphs provides a system, wherein the control circuit is configured to simultaneously operate the first downstream PCIe port in the pass-through mode and to operate the second downstream PCIe port in the authentication mode or vice versa.

### BRIEF DESCRIPTION OF THE DRAWINGS

A more complete understanding of the disclosure and the advantages thereof may be acquired by referring to the following description, taken in conjunction with the accompanying drawings and wherein:

FIG. 1 illustrates one of various examples of a system for authentication of PCIe devices via a switch.

FIG. 2 shows a block diagram of a system having a partitioned PCIe switch, a first host, a second host, a first PCIe device, and second PCIe device.

FIG. 3 shows a flow chart of a method for authentication of PCIe devices using a PCIe switch prior to allowing them to be connected to upstream PCIe hosts.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale.

### DETAILED DESCRIPTION

The present disclosure relates to electronic device networking and, more particularly, to a system for authenticating PCIe devices with a PCIe switch. The system enables authentication of PCIe devices using PCIe switch prior to allowing them to be connected to an upstream PCIe host.

A PCIe switch may authenticate the PCIe devices connected to it by playing the role of a CMA-SPDM requester (Component Measurement and Authentication-Security Protocol and Data Model), after which the authenticated devices will be connected to one of the upstream hosts. Authentication can be done over PCIe, TWI, SMBus, without limitation.

The system may include any secure system where authenticated PCIe devices are allowed in the PCIe topology of a host system.

Authentication driven by PCIe host may be defined in CMA-SPDM spec, and authentication is supported in the host system hardware and software. Examples of the present disclosure, instead, may provide a way to authenticate devices with any host, even if the host does not support CMA-SPDM.

Host system resources may be restricted from PCIe devices until their authenticity is validated. For example, a malicious device can cause host buffer overrun by returning recursive or long data structures even as part of authentication and exploit access to system memory.

As PCIe is gaining more and more adoption in automotive and other industries, threats of impersonation of devices and other such attacks exist. Authenticity of the PCIe devices in a system may be validated to prevent malfunction and misuse of the system

PCIe switch validation is an option where downstream devices can be validated before enabling connection to an upstream host.

Examples of the present disclosure may make CMA-SPDM authentication possible even in older systems that do not support authentication or not aware of authentication, without any hardware or software changes to those systems.

Examples of the present disclosure may enable PCIe switches to validate the authenticity of the PCIe devices connected to it so that authenticated downstream devices are connected to the upstream host, but unauthenticated downstream devices are not connected.

Devices failing authentication might not be connected to the upstream host, thereby minimizing the risk of malfunction as access to host system resources is denied.

Examples of the present disclosure may offload the host CPU or OS kernel from the need to authenticate PCIe devices, avoids hardware and device driver support in individual hosts.

While CMA-SPDM specification details authentication of PCIe devices from a root complex driven by the host CPU (the device is already in the host PCIe bus during authentication), examples of the present disclosure keep the devices isolated off the upstream host until authentication and then allow them to be connected to the upstream host

Individual hosts are attached to individual and separate partitions in the switch, respectively. At reset, all downstream ports of the PCIe switch are routed internally to the internal partition of the switch. Embedded CPU detects all PCIe devices connected to the internal partition. Embedded CPU drives public key cryptography-based authentication as a CMA-SPDM requester. Authentication can be over PCIe or MCTP or out-of-band like SMBus/I2C/I3C. Authentication can be validated at the device level or function level in case of a multi-function device or virtual function level in case of a SR-IOV device. If authentication is successful, the device is connected to an upstream host in the external partition. If authentication fails, one of the actions below is applied. Port is powered off, or port remains routed to the internal partition, without getting connected to any upstream host, or authentication is re-attempted after some time. Upon device removal, ports are re-routed to the internal partition of the switch.

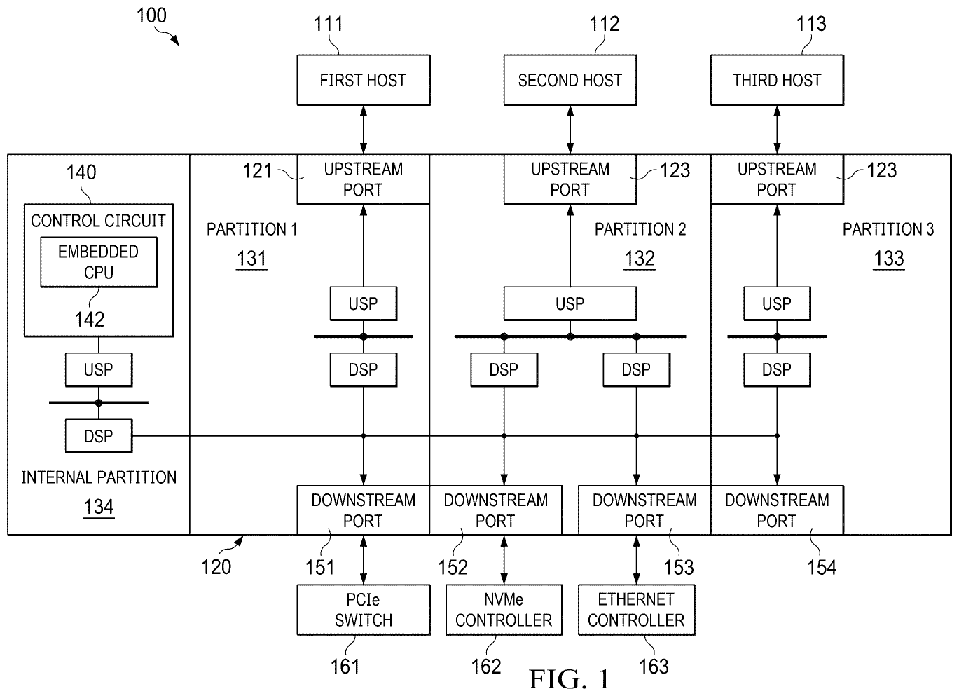

FIG. 1 illustrates one of various examples of a system 100 for authentication of PCIe devices. System 100 may include a first host 111, a second host 112 and a third host 113. The example of FIG. 1 includes three hosts, but this is not intended to be limiting.

First host 111 may be coupled to first PCIe switch 120 at first upstream port 121. First host 111 and first PCIe switch 120 may communicate via the PCIe communication protocol. Communication between first host 111 and first PCIe switch 120 may include, without limitation, memory read requests, memory write requests, input/output (I/O) read requests, I/O write requests, configuration read requests, configuration write requests, completion packets, and interrupt messages.

Second host 112 may be coupled to first PCIe switch 120 at second upstream port 122. Second host 112 and first PCIe switch 120 may communicate via the PCIe communication protocol. Communication between second host 112 and first PCIe switch 120 may include, without limitation, memory read requests, memory write requests, input/output (I/O) read requests, I/O write requests, configuration read requests, configuration write requests, completion packets, and interrupt messages.

Third host 113 may be coupled to first PCIe switch 120 at third upstream port 123. Third host 113 and first PCIe switch 120 may communicate via the PCIe communication protocol. Communication between third host 113 and first PCIe switch 120 may include, without limitation, memory read requests, memory write requests, input/output (I/O) read requests, I/O write requests, configuration read requests, configuration write requests, completion packets, and interrupt messages.

First PCIe switch 120 may be configured to include multiple partitions. In the example illustrated in FIG. 1, first PCIe switch 120 includes three partitions, a first partition 131, a second partition 132 and a third partition 133, but this is not intended to be limiting. The first PCIe switch 120 also has an internal partition 134.

First partition 131 may include first upstream port 121. First upstream port 121 may enable communication between first PCIe switch 120 and first host 111. First partition 131 may include first downstream port 151.

Second partition 132 may include second upstream port 122. Second upstream port 122 may enable communication between first PCIe switch 120 and second host 112. Second partition 132 may include second downstream port 152 and third downstream port 153.

Third partition 133 may include third upstream port 123. Third upstream port 123 may enable communication between first PCIe switch 120 and third host 113. Third partition 133 may include fourth downstream port 154.

The example illustrated in FIG. 1 includes three hosts, three upstream ports, and four downstream ports, but this is not intended to be limiting. Other examples may include a different number of hosts, upstream ports and downstream ports. Respective partitions may include one upstream port, and may include one downstream port or multiple downstream ports.

System 100 may be configured to authenticate devices connected to first downstream port 151, second downstream port 152, third downstream port 153 and fourth downstream port 154 prior to connecting them to their respective hosts. Specifically, such authentication may be enabled by control circuit 140. Control circuit 140 may be implemented in any suitable manner such as analog circuitry, digital circuitry, instructions for execution by a processor, a field programmable gate array, an application specific integrated circuit, programmable logic, an embedded processor, firmware, or any suitable combination thereof. Control circuit 140 may include or be communicatively coupled to an article of manufacture. The article of manufacture may be implemented as a non-transitory memory such as read only memory, random access memory, or any other suitable memory. The article of manufacture may include instructions. The instructions, when loaded and executed by a processor, may cause the processor to perform the operations of control circuit 140 as described in the present disclosure.

Control circuit 140 may include or may be communicatively coupled to an embedded central processing unit (CPU) 142. Embedded CPU 142 may be configured to run hypervisors, firmware, or any other suitable instructions.

In operation, one or more PCIe device may attach to first PCIe switch 120. When the one or more PCIe devices attach to first PCIe switch 120, control circuit 140 may start authentication using public key cryptography-based authentication method or other such methods.

In operation, second PCIe switch 161 may be coupled to first downstream port 151. Second PCIe switch 161 may be a hardware component physically coupled to first PCIe switch 120. Second PCIe switch 161 may be a hardware component coupled to first PCIe switch 120 over a wireless communication protocol. In the example illustrated in FIG. 1, second PCIe switch 161 may be coupled to first downstream port 151, but this is not intended to be limiting. In other examples, other PCIe devices may be coupled to first downstream port 151. Second PCIe switch 161 may communicate with first host 111.

In operation, Non-Volatile Memory Express (NVMe) controller 162 may be coupled to second downstream port 152. NVMe controller 162 may be part of a hardware component physically coupled to first PCIe switch 120. NVMe controller 162 may communicate with first PCIe switch 120 over a wireless communication protocol. In the example illustrated in FIG. 1, NVMe controller 162 may be coupled to second downstream port 152, but this is not intended to be limiting. In other examples, other PCIe devices may be coupled to second downstream port 152. NVMe controller 162 may communicate with second host 112 via second downstream port 152.

In operation, Ethernet controller 163 may be coupled to third downstream port 153. Ethernet controller 163 may be part of a hardware component physically coupled to first PCIe switch 120. Ethernet controller 163 may communicate with first PCIe switch 120 over a wireless communication protocol. In the example illustrated in FIG. 1, Ethernet controller 163 may be coupled to third downstream port 153, but this is not intended to be limiting. In other examples, other PCIe devices may be coupled to third downstream port 153. Ethernet controller 163 may communicate with second host 112 via third downstream port 153.

In one of various examples, first PCIe switch 120 may implement security protocols and prevent unapproved devices from communicating with first PCIe switch 120. In other examples, first PCIe switch 120 may be used in an automotive application or in a consumer electronics application to prevent components from unapproved vendors from communicating with at least one of first host 111, second host 112 and third host 113.

As described and illustrated in reference to FIG. 1, system 100 enables authentication of PCIe devices, allowing access to first PCIe switch 120 and preventing access to at least one of first host 111, second host 112 and third host 113 based on authentication information read from a PCIe device by the embedded CPU 142 in the internal partition 134. The system 100 enables authentication of PCIe devices 161, 162, and 163 using the embedded CPU 142 in the internal partition 134 of the PCIe switch 120 prior to allowing them to be connected to an upstream PCIe host 111, 112, or 113. The PCIe switch 120 may authenticate the PCIe devices 161, 162, and 163 connected to it by playing the role of a CMA-SPDM requester (Component Measurement and Authentication-Security Protocol and Data Model), after which the authenticated devices will be connected to one of the upstream hosts. 111, 112, or 113. Authentication can be done over PCIe, TWI, or SMBus, without limitation.

In one of various examples, system 100 may be an Advanced Driver Assistance System (ADAS) and first PCIe switch 120 may control communication between one or more hosts and one or more external components, including but not limited to graphics processing units, artificial intelligence (AI) accelerators, radar and lidar controllers, Network Interface Cards (NICs), storage devices, optical sensors and infotainment system controllers.

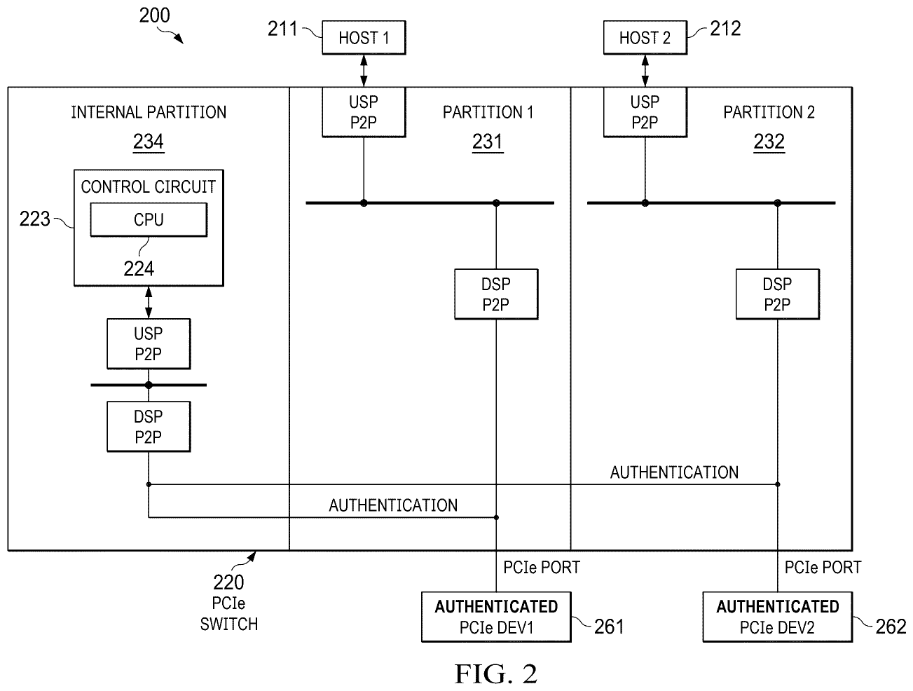

FIG. 2 shows a block diagram of a system 200. The system 200 has a PCIe switch 220, first host 211, second host 212, first PCIe device 261, and second PCIe device 262. The PCIe switch 220 has a first partition 231, a second partition 232, and an internal partition 234. The internal partition 234 has a control circuit 223 comprising, an embedded CPU 224.

The PCIe switch 220 may implement security protocols and prevent unapproved end point devices from communicating with the first and second hosts 211 and 212. In other examples, PCIe switch 220 may be used in an automotive application or in a consumer electronics application to prevent components from unapproved vendors from communicating with at least one of first host 211, and second host 212.

As described and illustrated in reference to FIG. 2, system 200 enables authentication of PCIe devices, allowing access to PCIe switch 220 and preventing access to at least one of first host 211, and second host 212 based on authentication information read from a PCIe device by the embedded CPU 224 and processing in the control circuit 223 in the internal partition 234. The system 200 enables authentication of PCIe devices 261 and 262 using the embedded CPU 224 in the internal partition 234 of the PCIe switch 220 prior to allowing them to be connected to an upstream PCIe host 211 or 112. The PCIe switch 220 may authenticate the PCIe devices 161 and 162 connected to it by playing the role of a CMA-SPDM requester (Component Measurement and Authentication-Security Protocol and Data Model), after which the authenticated devices will be connected to one of the upstream hosts 211 or 112. Authentication can be done over PCIe, TWI, or SMBus, without limitation.

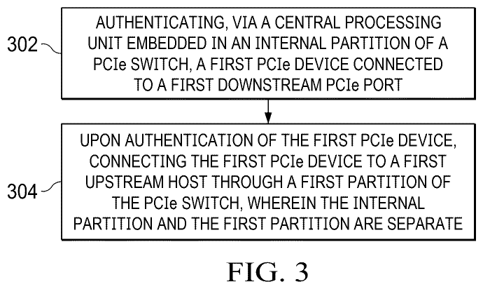

FIG. 3 shows a flow chart of a method for authentication of PCIe devices using a PCIe switch prior to allowing them to be connected to upstream PCIe hosts. A first PCIe device connected to a first downstream PCIe port is authenticated 302 via a control circuit embedded in an internal partition of a PCIe switch. Upon authentication of the first PCIe device, the first PCIe device is connected 304 to a first upstream host through a first partition of the PCIe switch, wherein the internal partition and the first partition are separate.

Although examples have been described above, other variations and examples may be made from this disclosure without departing from the spirit and scope of these disclosed examples.

1. An apparatus, comprising:
an upstream PCIe port configured to connect to a first host;
a first downstream PCIe port to connect to a first PCIe device through a first partition of the apparatus;
and
a control circuit of an internal partition of the apparatus configured to:
operate the first downstream PCIe port in an authentication mode;
detect attachment of the first PCIe device at the first downstream PCIe port;
authenticate the first PCIe device;
upon authentication of the first PCIe device, route the first PCIe device to the first upstream PCIe port for connection through the first partition to the first host; and
operate the first downstream PCIe port in a pass-through mode.

2. The apparatus of claim 1, comprising: a second upstream PCIe port configured to connect to a second host in a second partition of the apparatus, and a second downstream PCIe port configured to connect to a second PCIe device through a second partition of the apparatus, wherein:
the first host is configured to access the first upstream PCIe port in the first partition of the apparatus;
the second host is configured to access the second upstream PCIe port in the second partition of the apparatus; and
when one or more of the first and second downstream PCIe ports is in the authentication mode, the control circuit is configured to access the respective downstream ports from the internal partition of the apparatus, wherein the first partition, the second partition, and the internal partition of the apparatus are separate partitions.

3. The apparatus of claim 2, wherein the internal partition is isolated from the first host and the second host.

4. The apparatus of claim 1, wherein when the first downstream PCIe port is in the authentication mode the control circuit is configured to route PCIe signals between the first PCIe device connected to the first downstream PCIe port and the internal partition for authentication of the first PCIe device.

5. The apparatus of claim 4, wherein when the first downstream PCIe port is in the authentication mode the control circuit is configured to cause the first downstream PCIe port to isolate the first PCIe device from the first host before authentication of the first PCIe device.

6. The apparatus of claim 4, wherein when the first downstream PCIe port is in the pass-through mode the control circuit is configured to cause the first downstream PCIe port to allow the first PCIe device to be connected to the first host through the first partition after authentication of the first PCIe device connected to the first downstream PCIe port.

7. The apparatus of claim 4, wherein the control circuit is configured to switch operating the first downstream PCIe port between authentication mode and pass-through mode based on a predetermined event or a predetermined condition.

8. The apparatus of claim 2, wherein the control circuit is configured to simultaneously operate the first downstream PCIe port in the pass-through mode and to operate the second downstream PCIe port in the authentication mode or vice versa.

9. The apparatus of claim 1, wherein the first downstream PCIe port utilizes PCIe communication for authentication of the first PCIe device.

10. The apparatus of claim 1, wherein the first downstream PCIe port includes a separate authentication path from a PCIe pass-through path, wherein the authentication path is for authentication of the first PCIe device.

11. The apparatus of claim 2, wherein the control circuit is configured to handle PCIe device connect or removal events for the first downstream PCIe port and the second downstream PCIe port.

12. A method comprising:
authenticating, via a control circuit embedded in an internal partition of a PCIe switch, a first PCIe device connected to a first downstream PCIe port; and
upon authentication of the first PCIe device, connecting the first PCIe device to a first upstream host through a first partition of the PCIe switch, wherein the internal partition and the first partition are separate.

13. The method as in claim 12, wherein authenticating comprises operating the first downstream PCIe port in an authentication mode.

14. The method as in claim 12, wherein connecting comprises operating the first downstream PCIe port in a pass-through mode.

15. The method as in claim 12, comprising:
authenticating, via the control circuit, a second PCIe device connected to a second downstream PCIe port; and
upon authentication of the second PCIe device, connecting the second PCIe device to a second upstream host through a second partition of the PCIe switch, wherein the internal partition, the first partition, and the second partition are separate.

16. The method as in claim 15, wherein authenticating comprises operating the second downstream PCIe port in an authentication mode, and wherein connecting comprises operating the second downstream PCIe port in a pass-through mode.

17. The method as in claim 15, comprising simultaneously operating the first downstream PCIe port in the pass-through mode and operating the second downstream PCIe port in the authentication mode or vice versa.

18. A system, comprising:
a PCIe switch comprising:
a first upstream PCIe port connected to a first downstream PCIe port via a first partition;
a control circuit connected to the first downstream port via an internal partition, wherein the internal partition and the first partition are separate;
a first host connected to the first upstream PCIe port; and
a first downstream PCIe device connected to the first downstream PCIe port;
wherein the control circuit is configured to:
operate the first downstream PCIe port in an authentication mode;
detect attachment of the first PCIe device at the first downstream PCIe port;
authenticate the first PCIe device;
upon authentication of the first PCIe device, route the first PCIe device to the first upstream PCIe port for connection through the first partition to the first host; and
operate the first downstream PCIe port in a pass-through mode.

19. The system as in claim 18, wherein the PCIe switch comprises:
a second upstream PCIe port connected to a second downstream PCIe Port via a second partition, wherein the control circuit is connected to the second downstream port via the internal partition, wherein the internal partition and the second partition are separate;
wherein the system comprises:
a second host connected to the second upstream PCIe port;
a second downstream PCIe device connected to the second downstream PCIe port;
wherein the control circuit is configured to:
operate the second downstream PCIe port in an authentication mode;
detect attachment of the second PCIe device at the second downstream PCIe port;
authenticate the second PCIe device;
upon authentication of the second PCIe device, route the second PCIe device to the second upstream PCIe port for connection through the second partition to the second host; and
operate the second downstream PCIe port in a pass-through mode.

20. The system of claim 19, wherein the control circuit is configured to simultaneously operate the first downstream PCIe port in the pass-through mode and to operate the second downstream PCIe port in the authentication mode or vice versa.
